(19) United States
(12) Patent Application Publication
(10) Pub. No.: US 2024/0327587 A1
(43) Pub. Date: Oct. 3, 2024

(54) DISPERSANTS FOR SOLID-CONTAINING PHENOLIC FOAMS

(71) Applicant: Evonik Operations GmbH, Essen (DE)

(72) Inventors: Michael SUCHAN, Gelsenkirchen (DE); Sarah OTTO, Essen (DE)

(21) Appl. No.: 18/614,689

(22) Filed: Mar. 24, 2024

(30) Foreign Application Priority Data
Mar. 28, 2023 (EP) 23164585.4

(51) Int. Cl. C08J 9/00; C08J 9/14; C08K 3/32

(52) U.S. Cl. CPC C08J 9/0028; C08J 9/0066; C08J 9/141; C08J 2203/14; C08J 2361/06; C08K 3/32; C08K 2003/323; C08K 2201/003

(57) ABSTRACT

The invention relates to a composition for producing phenolic foam, comprising at least one phenolic resin, at least one blowing agent, at least one catalyst, and at least one solid, where the composition comprises at least one surfactant selected from the group of silicon-free quaternary ammonium compounds.

### CROSS REFERENCE TO RELATED APPLICATIONS

The present application claims priority under 35 USC § 119 to European application EP 23164585.4, filed on Mar. 28, 2023, the content of which is incorporated herein by reference in its entirety.

### FIELD OF THE INVENTION

The present invention is in the field of phenolic foams. In particular, it relates to a composition for producing phenolic foam, to a process for producing phenolic foam, to phenolic foam produced according to the invention and to the use thereof.

### BACKGROUND OF THE INVENTION

Phenolic foam is in the context of the present invention understood as meaning in particular a foam obtainable by reacting a phenolic resin with an acid as catalyst alongside addition of a blowing agent. Phenolic foams are known to those skilled in the art and described for example in EP 3830174 A1, DE 602004006376 T2, EP 2898005 A1, EP 1922357 A1, WO 2022043561 A1, EP 4073155 A1, AU 2021238847 A1 or WO 2006114777 A1. Phenolic foams are also referred to synonymously as phenolic resin foams.

In phenolic foam production it is customary to employ cell-stabilizing or foam-stabilizing additives to ensure a fine-celled, uniform and low-defect foam structure and hence to exert an essentially positive influence on the performance characteristics, for example the thermal insulation performance in particular, of the foam. It is usually possible to use for this purpose foam stabilizers, for example foam stabilizers based on ethoxylated vegetable oils such as castor oil, as described for example in EP 3830174 A1. The use of polyether-modified siloxanes (PES), as described for example in WO 2022043561 A1, has been found to be particularly effective at improving performance characteristics further. The combination of ethoxylated vegetable oils and polyether-modified siloxanes in particular results in excellent performance properties. This combination therefore represents a type of foam stabilizer that is usually preferred in the production of phenolic foam.

A particularly important aim associated with the provision of phenolic foams is that they should be produced particularly inexpensively. A further aim is that they should be produced in a particularly sustainable manner, for example by using biobased and/or recycled materials, and/or that the flame retardant properties should be improved, for example by adding flame retardants. It is possible to use for this purpose various solids. Corresponding solids suitable for use in phenolic foam are known per se.

However, the use of solids poses considerable problems with regard to dispersion in liquid feedstocks and processing. These include inter alia sedimentation, more difficult redispersion after sedimentation, inhomogeneous distribution in the phenolic foam and especially a resultant inhomogeneous property profile in the foams thus produced.

### BRIEF DESCRIPTION OF THE INVENTION

Against this background, the specific problem addressed by the present invention was that of making it possible to provide phenolic foams that comprise one or more solids but overcome the abovementioned problems of sedimentation, redispersion after sedimentation and/or inhomogeneous distribution in the material, in particular avoiding an excessive increase in the viscosity of the components.

In this regard, it was surprisingly found in the context of the present invention that the use of one or more surfactants selected from the group of silicon-free quaternary ammonium compounds, such as ester quats and/or alkyl quats, permits the desired significant improvement in redispersion and in sedimentation stability and also a more homogeneous property profile in the material. Advantageously, the viscosity of the components is here influenced only to a significantly lesser degree.

The specific problem addressed by the present invention is solved by the subject matter of the invention. The invention provides a composition for producing phenolic foam, comprising at least one phenolic resin, at least one blowing agent, at least one catalyst, and at least one solid, where the composition comprises at least one surfactant selected from the group of silicon-free quaternary ammonium compounds.

### DETAILED DESCRIPTION OF THE INVENTION

In the context of the present invention, a solid is understood as meaning a substance that is in the sold state at 25° C. and 101 325 kPa.

The subject matter of the invention is associated with a diversity of benefits. For instance, it makes it possible to provide phenolic foams having high solids contents. Advantageously, this is made possible without adversely affecting the other properties of the material, in particular the mechanical properties thereof. In particular, the phenolic foams have very good insulation properties and exhibit excellent long-term characteristics and high surface quality. The invention permits a particularly homogeneous distribution of solids in the phenolic foam. All in all, the invention permits easy processing of solids during production. The solid(s) can be introduced into the phenolic resin in a straightforward manner, for example together with the at least one surfactant selected from the group of silicon-free quaternary ammonium compounds, such as preferably ester quats and/or alkyl quats. The present invention allows problems with sedimentation during storage of the dispersion of phenolic resin and solid to be significantly reduced or even avoided. In particular, the invention also permits very good redispersibility of the solid in the event of sedimentation after very long storage, which means that, for example, constant stirring or mixing during storage is no longer necessary. The invention also permits more homogeneous distribution of the solid in the phenolic foam, which results in a more uniform property profile.

Surfactants from the group of silicon-free quaternary ammonium compounds, such as ester quats, amidoamine quats, imidazolinium quats, cetylpyridinium chloride and/or alkyl quats, are known per se to those skilled in the art. For instance, e.g. ester quats and alkyl quats are silicon-free quaternary ammonium compounds having at least one long hydrocarbon radical. Whereas alkyl quats are generally tetraalkylammonium salts, ester quats are generally based on quaternary triethanolmethylammonium compounds or quaternary diethanoldimethylammonium compounds esterified with at least one fatty acid.

Alkyl quats and ester quats have long been used in cosmetics or detergents and cleaning agents, for example fabric softeners, and the production thereof has long been known to those skilled in the art. Alkyl quats can be produced for example by reaction of the corresponding amine with methylating agents such as chloromethane or dimethyl sulfate. Ester quats can be produced for example by esterification of methyldiethanolamine or triethanolamine with fatty acids followed by quaternization with e.g. dimethyl sulfate or chloromethane.

The composition of the invention comprises at least one surfactant selected from the group of silicon-free quaternary ammonium compounds. According to a particularly preferred embodiment of the invention, the at least one surfactant is selected from the group consisting of ester quat of the formula (1), ester quat of the formula (2), alkyl quat of the formula (3), imidazolinium quat of the formula (4), amidoamine quat of the formula (5) and cetylpyridinium chloride, wherein in

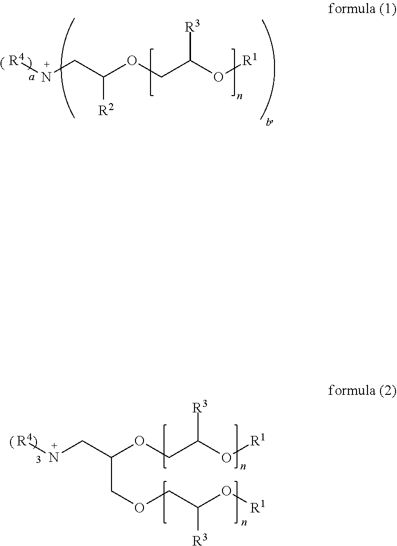

R¹ is an acyl radical of a saturated or mono- or polyunsaturated, linear or branched fatty acid having a chain length of 8 to 22 carbon atoms or the acyl radical of ricinoleic acid, or hydrogen, wherein a compound of the formula (1) or (2) may contain different radicals R¹ and with the proviso that at least one radical R¹ must be one of the stated acyl radicals,
R² is each independently an alkyl radical having 1 to 6 carbon atoms or hydrogen, preferably hydrogen, methyl, ethyl, propyl or isopropyl, more preferably hydrogen or methyl,
R³ is each independently an alkyl radical having 1 to 6 carbon atoms or hydrogen, preferably hydrogen, methyl, ethyl, propyl or isopropyl, more preferably methyl or hydrogen,
R⁴ is an alkyl radical having 1 to 6 carbon atoms or a hydroxyethyl radical or hydrogen, preferably methyl, ethyl, propyl or isopropyl, more preferably ethyl or methyl, most preferably methyl, it being possible for a compound of the formula (1) and/or (2) to contain different radicals R⁴, and
where n=0 to 20, preferably 0 to 10, more preferably 0,
where a=1 to 3 and b=1 to 3,
with the proviso that a+b=4,
and/or wherein in

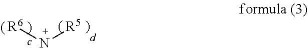

R⁵ is a saturated or mono- or polyunsaturated, linear or branched alkyl radical having a chain length of 8 to 24 carbon atoms, it being possible for a compound of the formula (3) to contain different radicals R⁵,
R⁶ is an alkyl radical having 1 to 6 carbon atoms or a hydroxyethyl radical or a benzyl radical or hydrogen, preferably methyl, ethyl, propyl, isopropyl or benzyl, more preferably ethyl or methyl, very particularly preferably methyl,
it being possible for a compound of the formula (3) to contain different radicals R⁶ and
where c=1 to 3 and d=1 to 3
with the proviso that c+d=4
and/or wherein in

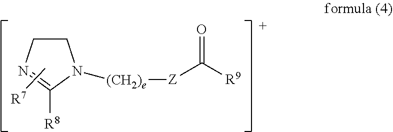

R⁷ is an alkyl radical having 1 to 6 carbon atoms or a hydroxyethyl radical or hydrogen, preferably methyl, ethyl, propyl or isopropyl, more preferably ethyl or methyl, most preferably methyl,
R⁸ is a saturated or mono- or polyunsaturated, linear or branched alkyl radical having 8 to 22 carbon atoms or a radical O (CO) R¹⁰, where R¹⁰ is an aliphatic, saturated or mono- or polyunsaturated, linear or branched alkyl radical having 7 to 21 carbon atoms,
R⁹ is an aliphatic, saturated or mono- or polyunsaturated, linear or branched alkyl radical having 7 to 21 carbon atoms,
Z is an NH group or oxygen,
where e can be an integer between 1 and 4,
and/or wherein in

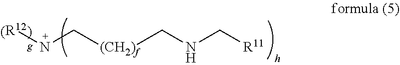

R¹¹ is a saturated or mono- or polyunsaturated, linear or branched alkyl radical having a chain length of 7 to 21 carbon atoms,
R¹² is an alkyl radical having 1 to 6 carbon atoms or a hydroxyethyl radical or hydrogen, preferably methyl, ethyl, propyl or isopropyl, more preferably ethyl or methyl, most preferably methyl, it being possible for a compound of the formula (5) to contain different radicals R¹² and
where f can be an integer between 0 and 5,
where h=1 or 2 and g=2 or 3,
with the proviso that h+g=4,
it being possible for a compound of the formula (5) in which h=2 to have different values for f and to contain different radicals R¹¹
and if R⁴, R⁶, R⁷ or R¹² includes a hydroxyethyl radical, this may also be alkoxylated and this optionally alkoxylated hydroxyethyl radical may contain repeat units based on ethylene oxide, propylene oxide, butylene oxide and/or styrene oxide and comprise 1-15 repeat units, preferably 1-10 repeat units.

It is possible to use one or more than one of the surfactants of the invention selected from the group of silicon-free quaternary ammonium compounds, in particular those described above, i.e. it is also possible to use any desired mixtures of such surfactants. The use of ester quat of the formula (1) and/or ester quat of the formula (2) is particularly preferred here. It is thus particularly preferable to use at least one surfactant, selected from the group consisting of ester quat of the formula (1) and ester quat of the formula (2).

Corresponding compositions comprising one or more of the corresponding silicon-free quaternary ammonium compounds show particularly advantageous results in respect of the above-described advantages of the invention.

It corresponds to a further particularly preferred embodiment of the invention, when, in formula (1) and/or formula (2), R¹ is each independently selected from acyl radicals of acids from the group consisting of oleic acid, isostearic acid, lauric acid, palmitic acid, elaidic acid, vaccenic acid, gadoleic acid, eicosenoic acid, cetoleic acid, erucic acid, nervonic acid, linoleic acid, alpha-linolenic acid, gamma-linolenic acid, calendic acid, punicic acid, alpha-eleostearic acid, beta-eleostearic acid, arachidonic acid, timnodonic acid, clupanodonic acid and cervonic acid.

It is further preferable when, in formula (1), a=b=2 and/or, in formula (5), h=1 and g=3. This likewise corresponds to a further particularly preferred embodiment of the invention.

A composition of the invention additionally comprising at least one counteranion to the compounds of the general formulas (1), (2), (3), (4) and/or (5) selected from the group consisting of chloride, bromide, iodide, alkyl sulfate, ethylsulfate, alkyl sulfonate, triflate, tosylate, phosphate, sulfate, hydrogen sulfate, lactate, glycolate, acetate and citrate corresponds to a further particularly preferred embodiment of the invention.

A particularly preferred composition of the invention has the characteristic feature that the at least one solid is selected from the group consisting of
(a) solid flame retardants, preferably ammonium polyphosphate, melamine, melamine-coated ammonium polyphosphate, ammonium polyphosphate microencapsulated in melamine, ammonium polyphosphate microencapsulated in melamine-formaldehyde resin, melamine cyanurate, red phosphorus, zinc borate, melamine polyphosphate, expandable graphite and/or antimony trioxide, especially red phosphorus and/or ammonium polyphosphate,
(b) plastic powder, and
(c) calcium carbonate, graphite, graphene, lignin, lignocellulose, metal hydroxides, preferably aluminium hydroxide and/or magnesium hydroxide, metal carbonates, preferably calcium carbonate, magnesium carbonate, barium carbonate and/or zinc carbonate, metal oxides, preferably aluminium oxide and/or zinc oxide and/or metal powders, preferably zinc.

This too corresponds to a particularly preferred embodiment of the invention.

It is possible to use one or more than one of the solids of the invention, in particular those described above, i.e. it is also possible to use any desired mixtures of such solids.

The at least one solid is in particular in powder form. This corresponds to a particularly preferred embodiment of the invention. Preferred particle sizes are detailed further below.

Solid flame retardants, which are employable with preference for use in phenolic foams, are likewise known per se and the present invention is also not limited in the selection of solid flame retardants. However it corresponds to a preferred embodiment of the invention when certain solid flame retardants, in particular those mentioned above, are used in the composition of the invention. It is possible to use one or more than one solid flame retardant, i.e. it is also possible to use any desired mixtures thereof. Very particular preference is given to using red phosphorus and/or ammonium polyphosphate.

It is a particularly preferred embodiment of the invention when red phosphorus and/or ammonium polyphosphate are present as a solid flame retardant in the composition of the invention.

It is a further particularly preferred embodiment of the invention when at least one plastic powder is present in the composition of the invention, the at least one plastic powder consisting of at least one plastic selected from the group consisting of polyethylene, polypropylene, polyamide, such as in particular PA6, PA6.6, PA10, PA11 and/or PA12, polyester, such as in particular polyethylene terephthalate, polybutylene terephthalate and/or poly-&-caprolactone, polystyrene, polyacrylate, polymethyl methacrylate, polycarbonate, styrene-acrylonitrile copolymers, polyether, polylactic acid, polyurethane, phenolic resin, phenolic foam, polysulfone, polyethersulfone, polyetherimide and polyimide or mixtures thereof; wherein said plastic powder may be particularly preferably produced from waste plastics, especially preferably from phenolic resin and/or phenolic foam waste plastics.

It is possible to use one or more than one plastic powder, in particular those described above, i.e. it is also possible to use any desired mixtures of such plastic powders.

A waste plastic is in particular a plastic that
(i) results from production waste obtained during plastics production, for example cutting waste, sawing waste or material that does not pass quality control, and/or
(ii) results from plastics that have reached the end of their service life, for example plastics based on phenolic foams from used insulation materials or insulation panels, or other used plastic components and semifinished plastic products.

It is in turn then a further particularly preferred embodiment of the invention when one or more plastic powders from waste plastics, preferably from phenolic resin waste plastics, especially preferably from phenolic foam waste plastics, are present in the composition of the invention.

A further preferred embodiment of the invention is then when the composition of the invention has the characteristic feature that the solid(s) are a powder, preferably having an average particle diameter of <500 μm, preferably<250 μm, especially preferably<150 μm, preferably determined as volume-based median value by laser diffraction spectroscopy in accordance with ISO 13320:2020. The average diameter of the particles is here determined in accordance with ISO 13320:2020 by laser diffraction spectroscopy. Values for the average diameter (i.e. for the average particle diameter) correspond to the volume-based median value and thus give the diameter of a sphere of equivalent volume relative to which 50% of the particles are smaller and 50% of the particles are larger.

It is a further particularly preferred embodiment of the invention when a composition of the invention has the characteristic feature that the at least one surfactant from the group of silicon-free quaternary ammonium compounds is present in a total amount of 0.1 to 20 parts by weight, preferably 0.1 to 15 parts by weight, more preferably 0.1 to 10 parts by weight, based on 100 parts by weight of the total phenolic resin used.

According to a further preferred embodiment of the invention, the at least one solid is present in the composition of the invention in a total amount of 1 to 100 parts by weight, preferably 1 to 60 parts by weight, more preferably 5 to 50 parts by weight, based on 100 parts by weight of the total phenolic resin used.

A further preferred embodiment of the invention is when the composition of the invention has the characteristic feature that alkoxylated, preferably ethoxylated, castor oil in a total amount of 0.5 to 10 parts by weight, preferably 1 to 8 parts by weight, based on 100 parts by weight of the total phenolic resin used, is additionally present and/or that at least one polyether siloxane is additionally present in an amount of 0.5 to 10 parts by weight, based on 100 parts by weight of the total phenolic resin used.

Polyether siloxanes, also termed polyether-modified siloxanes (PES), are known per se and are described further below.

It is a further preferred embodiment of the invention when the composition of the invention has the characteristic feature that the at least one blowing agent is selected from the group consisting of
hydrocarbons having 3, 4 or 5 carbon atoms, preferably cyclo-, iso- and/or n-pentane, and
halogenated hydrocarbons having 3, 4 or 5 carbon atoms, preferably hydrofluoroolefins and/or hydrohaloolefins, further preferably 1234ze, 1234yf, 1224 yd, 1233zd (E) and/or 1336mzz.

It is possible to use one or more than one blowing agent, in particular those described above, i.e. it is also possible to use any desired mixtures of blowing agents.

The invention further provides a process for producing phenolic foam using a reaction mixture that comprises a composition comprising at least one phenolic resin, at least one blowing agent, at least one catalyst and at least one solid, where the composition comprises at least one surfactant selected from the group of silicon-free quaternary ammonium compounds, for example ester quat or alkyl quat or amidoamine quat or imidazolinium quat, in particular as described above in more detail in the preferred embodiments.

A particularly preferred phenolic foam formulation for the purposes of the present invention gives a foam density of 5 to 900 kg/m³ and has preferably the composition shown in Table 1, which corresponds to a preferred embodiment of the invention:

TABLE 1
Composition of a preferred phenolic foam formulation

| Component | Parts by weight |
|---|---|
| Phenolic resin | 80 to 120 |
| Surfactant(s) from the group of silicon-free | 0.1 to 20 |
| quaternary ammonium compounds, preferably | |
| according to formula (1), (2), (3), (4) | |
| and/or (5) | |
| Solids | 1 to 100 |
| Blowing agent | >0 to 50 |
| Catalyst | 1 to 30 |
| Foam stabilizers that are not surfactants | >0 to 15 |
| from the group of silicon-free quaternary | |
| ammonium compounds | |
| Optionally further additives | 0 to 100 |

For further preferred embodiments and configurations of the process of the invention, reference is also made to the details previously given above in connection with the composition of the invention.

The present invention further provides a phenolic foam produced by the abovementioned process of the invention, in particular using a composition of the invention.

The present invention further provides for the use of the phenolic foam of the invention, as mentioned above, as a material for thermal insulation, preferably as an insulation panel or sandwich element.

A particularly preferred composition of the invention comprises the following constituents:
at least one phenolic resin,
at least one surfactant selected from the group of silicon-free quaternary ammonium compounds, in particular as defined above by formula (1), (2), (3), (4) and/or (5) and/or cetylpyridinium chloride,
at least one blowing agent,
at least one catalyst,
at least one foam stabilizer that is not a surfactant from the group of silicon-free quaternary ammonium compounds,
at least one solid,
optionally further additives, etc.

The production of phenolic foams (these are referred to synonymously, including in the context of the present invention, as phenolic resin foams) is known per se. Phenolic foams can be produced using one or more than one phenolic resin, preferably one or more than one of the type known as resol resins. Suitably employable phenolic resins, preferably resol resins, are known per se. In particular, they may be produced in a known manner, for example by condensation of phenol or a phenol-based compound such as cresol, xylenol, para-alkyl phenol, para-phenylphenol, resorcinol or the like and an aldehyde such as formaldehyde, furfural, acetaldehyde or the like under preferably basic conditions, for example by using a catalytic amount of alkali metal hydroxides, for example sodium hydroxide, potassium hydroxide or calcium hydroxide or an aliphatic amine, for example trimethylamine or triethylamine, preferably with the aldehyde in excess. This represents the usual way of producing phenolic resins, preferably resol resins, the invention not being limited just to the chemicals listed immediately above.

The molar ratio of phenol groups to aldehyde groups is not subject to any restriction. Preferably, the ratio is within a range from 1:1 to 1:3, more preferably within a range from 1:1.5 to 1:2.5. Preferably, but not limited thereto, the phenolic resin has a free aldehyde content of 0.1% by weight to 0.5% by weight. This can be determined by potentiometric titration according to ISO 11402:2004 with hydroxylamine hydrochloride.

Preferred phenolic resins that can be used in foam production are liquids at 25° C. and standard pressure, preferably have water concentrations of from about 1% to 25% by weight, preferably 5% to 20% by weight, and have methylol groups as reactive substituents, as described for example in EP 0170357 B1. If desired, the viscosity of the phenolic resin can be through, inter alia, the water content. Thus, high water contents usually result in lower viscosity, which facilitates both the handling of the resin and its mixing during foam production.

The viscosity of preferred phenolic resins at 25° C. and standard pressure is preferably within a range from 1000 to 28 000 mPa's and can be determined by the usual methods known to those skilled in the art, for example using a Brookfield viscometer. The fundamentals on the production and composition of phenolic resins can be found in the prior art and in particular are described for example in EP 3830174 A1, EP 2898005 A1, WO 2022043561 A1 or EP 4073155 A1.

Surfactants of the invention from the group of silicon-free quaternary ammonium compounds, in particular as defined above by formula (1), (2), (3), (4) and/or (5) and/or cetylpyridinium chloride, have already been described further above.

Blowing agents and the use thereof in the production of phenolic foams are known to those skilled in the art. The use of one or more blowing agents depends in principle on the nature of the system and on the use for the phenolic foam obtained. Depending on the amount of blowing agent used, a foam having high or low density can be produced. For instance, it is possible to produce according to ASTM D1622-20 foams having densities of preferably 5 kg/m³ to 900 kg/m³, preferably 5 to 500 kg/m³, more preferably 10 to 200 kg/m³, especially 12 to 100 kg/m³.

The blowing agent used may be one or more of the appropriate compounds having suitable boiling points, for example hydrocarbons having 3, 4 or 5 carbon atoms, preferably cyclo-, iso- or n-pentane, halogenated hydrocarbons, for example chlorinated hydrocarbons such as dichloroethane, 1,2-dichloroethene, n-propyl chloride, isopropyl chloride, butyl chloride, Isobutyl chloride, pentyl chloride, isopentyl chloride, 1,1-dichloroethene, trichloroethene or chloroethene, or hydrofluorocarbons (HFCs), for example HFC 245fa, HFC 134a or HFC 365mfc, hydrofluoroolefins (HFOs) or hydrohaloolefins, preferably 1234ze, 1234yf, 1224 yd, 1233zd (E) or 1336mzz or mixtures thereof.

Catalysts that can be used for the production of phenolic foams are known from the prior art to those skilled in the art and described for example in EP 0170 357 A1 or in DE 602004006376 T2. The customary organic and inorganic acids known from the prior art can be employed with preference for this purpose. It is possible to use one or more than one acid. Employable with particular preference are sulfuric acid, phosphoric acid, benzenesulfonic acid, xylenesulfonic acid, para-toluenesulfonic acid, ethylbenzenesulfonic acid, naphthalenesulfonic acid, cumenesulfonic acid and/or phenolsulfonic acid. In particular, catalysts used may be mixtures of a plurality of these compounds. The preferred amount of catalysts employed for a complete reaction is influenced inter alia by the water content of the phenolic resin and/or—when the catalyst is present as an aqueous solution—also by the water content thereof. For example, a higher water content may necessitate a higher acid concentration.

Phenolic foam can be formed in a known manner, i.e. especially through reaction of a mixture comprising phenolic resin, blowing agent, foam stabilizer and catalyst. When a catalyst is added to a mixture of phenolic resin, blowing agent and foam stabilizer, an exothermic reaction occurs between the methylol groups and phenol that results in the formation of methylene bridges and crosslinking. The condensation is accompanied by the liberation of water. The exothermicity of the reaction and foam formation are influenced by the nature and amount of the acid used, the properties of the blowing agent and the structure of the foam stabilizer.

Foam stabilizers and the use thereof in the production of phenolic foams are well known to those skilled in the art, as described above. For example, EP 3830174 A1 describes the use of ethoxylated castor oil and WO 2022043561 A1 the use of ethoxylated castor oil and polyether-modified siloxanes. The use of ethoxylated castor oil and the use of ethoxylated castor oil and polyether-modified siloxanes correspond to preferred embodiments of the invention.

Solids have already been described further above.

Optional additives used may be one or more of the substances known from the prior art that are commonly used in the production of phenolic foams, for example viscosity reducers, plasticizers, hardeners, liquid flame retardants, cell-refining additives, dyes and/or fragrances. Suitable optional additives are described for example in EP 3830174 A1, U.S. Pat. No. 4,444,912 A and EP 1922357 A1.

The viscosity of the phenolic resin can be reduced using for example monoethylene glycol or polyester polyols. Hardeners used may be for example be compounds having amino groups, such as urea or dicyandiamide. Preference is given to using urea. These can be used additionally for foaming as well as for the production of the phenolic resin.

The process of the invention for producing phenolic foams can be executed according to all known methods. These are known to those skilled in the art and are described for example in EP 3830174 A1.

Unless the opposite is apparent from this description, it is possible to combine any preferred or particularly preferred embodiment of the invention with one or more of the other preferred or particularly preferred embodiments of the invention.

The subject matter of the invention is described below by way of example, without any intention of restricting the invention, the scope of application of which is apparent from the entirety of the description and the claims, to these exemplary embodiments. Where ranges, general formulas or classes of compounds are stated, these are intended to encompass not just the corresponding ranges or groups of compounds explicitly mentioned but also all subranges and subgroups of compounds that can be obtained by removing individual values (ranges) or compounds. Where documents are cited in the context of the present description, the entire content thereof, particularly with regard to the subject matter that forms the context in which the document has been cited, is intended to form part of the disclosure content of the present invention. Unless otherwise stated, percentages are in weight percent. Where average values are reported, these are numerical averages unless otherwise stated. Where parameters that have been determined by measurement are reported, the measurements have unless otherwise stated been carried out at a temperature of 23° C. and standard pressure.

### EXAMPLES

### Example 1: Production of the Phenolic Foam

For the performance comparison, the formulations in Table 2 and the dispersants in Table 3 were selected.

The comparative foaming operations were carried out with manual mixing. For this, phenolic resin (amount per batch: 180±5 g), foam stabilizers, dispersant, and solid material were weighed into a beaker and mixed with a disc stirrer (diameter 6 cm) at 20° C. and 500 rpm for 15 s. The blowing agent was then added and the mixture was mixed at 1500 rpm for 30 s and then cooled to 18° C. The acid was then added and the mixture stirred at 2000 rpm for 45 s and transferred to a 25 cm×25 cm×7 cm aluminium mould lined with polyethylene film and thermostated to 50° C. After 1 h, the foams were demoulded and hardened in an oven heated to 60° C. for 18 h.

TABLE 2
Formulation for producing phenolic foam.
Amounts stated are in parts by weight.

| | Formu- | Formu- | Formu- | Formu- | Formu- |
|---|---|---|---|---|---|
| Component | la A | la B | la C | la D | la E |
| Phenolic resin* | 100 | 100 | 100 | 100 | 100 |
| TAGAT ® CH 40** | 3 | 3 | 3 | 3 | 3 |
| TEGOSTAB ® B | 2 | 2 | 2 | 2 | 2 |
| 84905*** | | | | | |
| Dispersant | 5 | 2 | 2 | 8 | 2 |
| Red phosphorus | 10 | | | | |
| Ammonium | | 10 | | | |
| polyphosphate | | | | | |
| Melamine | | | 10 | | |
| Recycled phenolic | | | | 5 | |
| foam**** | | | | | |
| Lignin from hardwood | | | | | 10 |
| Cyclo-/isopentane | 10 | 10 | 10 | 10 | 10 |
| 85/15 | | | | | |
| p-Toluenesulfonic acid | 18 | 18 | 18 | 18 | 18 |
| 65% in water | | | | | |

*Phenolic resin Cellobond ® J6014L from Bakelite
**Foam stabilizer from Evonik Operations GmbH
***Foam stabilizer from Evonik Operations GmbH
****Phenolic foam insulation panel ground in a pinned-disk mill (cryogenic grinding with liquid nitrogen, circumferential speed 120 m/s)

TABLE 3
Compounds investigated

| Name | Type | Composition |
|---|---|---|
| Compound 1 | Ester quat | Dimethyl, diisopropyl ester quat of isostearic acid |
| | | and oleic acid (methylsulfate) |
| Compound 2 | Ester quat | Methyl, hydroxyethyl, dihydroxyethyl oleate ester |
| | | quat (methylsulfate) |
| Compound 3 | Ester quat | Methyl, hydroxyethyl, dihydroxyethyl tallowate ester |
| | | quat (methylsulfate) |
| Compound 4 | Ester quat | Methyl, hydroxyethyl, dihydroxyethyl palmeate |
| | | ester quat (methylsulfate) |
| Compound 5 | Ester quat | Dimethyl, dihydroxyethyl tallowate ester quat |
| | | (chloride) |
| Compound 6 | Alkyl quat | Behenyl (C22) trimethylammonium chloride |
| Compound 7 | Alkyl quat | Distearyldimethylammonium chloride |
| Compound 8 | Alkyl quat | Ethyl-bis(polyethylene glycol) tallyl-ammonium |
| | | ethylsulfate (total 10 EO units) |
| Compound 9 | Alkyl quat | Methyl-bis(polyethylene oxide)coco-ammonium |
| | | chloride (total 15 EO units) |
| Compound 10 | Alkyl quat | Methyl-bis(polyethylene oxide)coco-ammonium |
| | | methylsulfate (total 5 EO units) |
| Compound 11 | Imidazolinium quats | Dioleyl imidazolinium quat (methylsulfate, |
| | | R⁷ = methyl, e = 2, Z = N) |
| Compound 12 | Imidazolinium quats | Dipalmityl imidazolinium quat (methylsulfate, |
| | | R⁷ = methyl, e = 2, Z = N) |
| Compound 13 | Amidoamine quat | Methyl, polyethylene oxide, dipalm stearin |
| | | amidoamine quat (f = 0, 3.5 EO, methylsulfate) |
| Compound 14 | Amidoamine quat | Methyl, polyethylene oxide, diisostearin |
| | | amidoamine quat (f = 0, 3.0 EO, methylsulfate) |
| Cetylpyridinium | — | — |
| chloride | | |
| TEGOPREN ® 6921 | Silicone quat | Noninventive |
| TEGOTEX ® 8080 | Silicone quat | Noninventive |
| TEGO ® Dispers 652 | Modified derivatives | Noninventive |
| | based on tallow oil | |

The surface and pore structure were subjectively assessed on a scale from 1 to 10, where 10 represents an (idealized) defect-free, very fine foam and 1 represents a very significantly defective, coarse foam. The thermal conductivity coefficient (A value in mW/m·K) was measured on 2.5 cm-thick discs with an instrument of the Hesto Lambda Control type, model HLC X206, at an average temperature of 10° C. in accordance with the specifications of standard EN12667:2001. Density was determined according to ASTM D1622-20.

The results are shown in Tables 4 to 8.

TABLE 4
Foam properties: Phenolic foam of formula A.

| | | | | Cell |
|---|---|---|---|---|
| | | | Cell | structure |
| | Density in | λ value in | structure | internal |
| Compound | kg/m³ | mW/m · K | surface | defects |
| Without dispersant | 39.4 | 23.9 | 6.0 | 6.0 |
| additive | | | | |
| Compound 1 | 39.1 | 22.9 | 7.0 | 7.0 |
| Compound 2 | 38.8 | 22.9 | 7.0 | 6.5 |
| Compound 3 | 39.4 | 22.8 | 6.5 | 6.5 |
| Compound 4 | 39.5 | 23.4 | 6.5 | 6.0 |
| Compound 5 | 39.8 | 23.8 | 6.5 | 6.5 |
| Compound 6 | 39.2 | 21.9 | 7.0 | 7.5 |
| Compound 7 | 38.4 | 22.8 | 7.0 | 7.0 |
| Compound 8 | 40.0 | 23.0 | 6.5 | 7.0 |
| Compound 9 | 39.4 | 23.1 | 7.5 | 7.0 |
| Compound 10 | 39.1 | 23.3 | 6.5 | 6.5 |
| Compound 11 | 39.8 | 22.9 | 6.5 | 7.0 |
| Compound 12 | 39.5 | 23.7 | 6.5 | 6.5 |
| Compound 13 | 39.7 | 22.8 | 7.0 | 7.0 |
| Compound 14 | 39.2 | 23.0 | 6.5 | 7.0 |
| Cetylpyridinium | 40.1 | 23.9 | 6.0 | 6.0 |
| chloride | | | | |
| TEGOPREN ® 6921 | 48.1 | >28 | 3.0 | 3.0 |
| TEGOTEX ® 8080 | 50.2 | >28 | 2.0 | 2.0 |
| TEGO ® Dispers 652 | 39.7 | 24.2 | 5.5 | 5.0 |

TABLE 5
Foam properties: Phenolic foam of formula B.

| | | | | Cell |
|---|---|---|---|---|
| | | | Cell | structure |
| | Density in | λ value in | structure | internal |
| Compound | kg/m³ | mW/m · K | surface | defects |
| Without dispersant | 39.0 | 23.4 | 5.5 | 6.0 |
| additive | | | | |
| Compound 1 | 38.9 | 23.0 | 7.0 | 7.0 |
| Compound 2 | 38.9 | 23.1 | 6.0 | 6.0 |
| Compound 3 | 38.1 | 23.0 | 6.5 | 6.5 |
| Compound 4 | 38.8 | 23.3 | 7.0 | 6.5 |
| Compound 5 | 38.2 | 22.5 | 6.0 | 6.0 |
| Compound 6 | 38.1 | 22.8 | 6.5 | 6.5 |
| Compound 7 | 38.4 | 22.4 | 6.5 | 6.5 |
| Compound 8 | 38.5 | 22.9 | 7.0 | 6.5 |
| Compound 9 | 38.4 | 22.1 | 7.0 | 7.0 |
| Compound 10 | 38.7 | 23.3 | 6.0 | 6.5 |
| Compound 11 | 37.9 | 23.0 | 6.5 | 6.5 |
| Compound 12 | 38.7 | 22.8 | 7.0 | 7.0 |
| Compound 13 | 38.8 | 22.7 | 6.5 | 7.0 |
| Compound 14 | 38.5 | 23.1 | 6.0 | 7.0 |
| Cetylpyridinium | 39.2 | 24.2 | 5.5 | 6.0 |
| chloride | | | | |
| TEGOPREN ® 6921 | 43.7 | >28 | 4.0 | 4.0 |
| TEGOTEX ® 8080 | 47.6 | >28 | 3.0 | 2.0 |
| TEGO ® Dispers 652 | 40.0 | 23.9 | 5.0 | 5.5 |

TABLE 6
Foam properties: Phenolic foam of formula C.

| | | | | Cell |
|---|---|---|---|---|
| | | | Cell | structure |
| | Density in | λ value in | structure | internal |
| Compound | kg/m³ | mW/m · K | surface | defects |
| Without dispersant | 38.1 | 23.0 | 6.5 | 6.0 |
| additive | | | | |
| Compound 1 | 38.2 | 21.6 | 7.0 | 6.5 |
| Compound 2 | 38.0 | 22.2 | 6.5 | 6.5 |
| Compound 3 | 37.8 | 22.4 | 6.5 | 6.5 |
| Compound 4 | 37.4 | 22.6 | 7.5 | 7.5 |
| Compound 5 | 38.0 | 21.9 | 6.0 | 7.0 |
| Compound 6 | 38.2 | 22.8 | 7.0 | 6.5 |
| Compound 7 | 37.6 | 22.1 | 7.0 | 6.5 |
| Compound 8 | 37.9 | 22.4 | 7.5 | 6.5 |
| Compound 9 | 37.4 | 22.3 | 7.5 | 6.5 |
| Compound 10 | 38.0 | 22.7 | 6.5 | 6.5 |
| Compound 11 | 38.1 | 21.5 | 7.5 | 7.0 |
| Compound 12 | 37.8 | 21.8 | 7.0 | 7.5 |
| Compound 13 | 37.5 | 22.0 | 7.0 | 7.0 |
| Compound 14 | 37.4 | 22.5 | 6.5 | 7.0 |
| Cetylpyridinium | 38.2 | 22.8 | 6.5 | 6.5 |
| chloride | | | | |
| TEGOPREN ® 6921 | 42.4 | >28 | 3.0 | 3.0 |
| TEGOTEX ® 8080 | 46.0 | >28 | 3.0 | 3.0 |
| TEGO ® Dispers 652 | 39.7 | 24.5 | 5.5 | 5.0 |

TABLE 7
Foam properties: Phenolic foam of formula D.

| | | | | Cell |
|---|---|---|---|---|
| | | | Cell | structure |
| | Density in | λ value in | structure | internal |
| Compound | kg/m³ | mW/m · K | surface | defects |
| Without dispersant | 38.5 | 24.1 | 6.5 | 6.5 |
| additive | | | | |
| Compound 1 | 38.5 | 23.5 | 7.0 | 7.0 |
| Compound 2 | 38.7 | 23.4 | 7.0 | 6.5 |
| Compound 3 | 38.0 | 23.9 | 7.5 | 7.5 |
| Compound 4 | 38.4 | 23.5 | 6.5 | 7.0 |
| Compound 5 | 38.0 | 24.0 | 6.5 | 6.5 |
| Compound 6 | 38.2 | 23.5 | 7.0 | 7.5 |
| Compound 7 | 37.8 | 23.2 | 7.0 | 7.5 |
| Compound 8 | 38.7 | 23.7 | 6.5 | 7.0 |
| Compound 9 | 37.9 | 24.0 | 7.0 | 7.0 |
| Compound 10 | 39.0 | 23.5 | 6.5 | 7.0 |
| Compound 11 | 37.4 | 23.0 | 7.0 | 7.5 |
| Compound 12 | 38.2 | 22.8 | 7.0 | 8.0 |
| Compound 13 | 38.4 | 24.0 | 6.5 | 6.5 |
| Compound 14 | 38.0 | 23.7 | 7.0 | 6.5 |
| Cetylpyridinium | 39.2 | 24.1 | 6.5 | 6.5 |
| chloride | | | | |
| TEGOPREN ® 6921 | 42.1 | >28 | 2.0 | 2.0 |
| TEGOTEX ® 8080 | 45.9 | >28 | 3.0 | 4.0 |
| TEGO ® Dispers 652 | 39.9 | 26.6 | 5.5 | 6.0 |

TABLE 8
Foam properties: Phenolic foam of formula E.

| | | | | Cell |
|---|---|---|---|---|
| | | | Cell | structure |
| | Density in | λ value in | structure | internal |
| Compound | kg/m³ | mW/m · K | surface | defects |
| Without dispersant | 40.7 | 24.5 | 5.0 | 6.0 |
| additive | | | | |
| Compound 1 | 39.7 | 24.0 | 6.0 | 6.5 |
| Compound 2 | 40.2 | 23.8 | 6.0 | 6.5 |
| Compound 3 | 40.1 | 23.7 | 6.0 | 7.0 |
| Compound 4 | 39.8 | 23.9 | 5.5 | 6.5 |
| Compound 5 | 40.0 | 24.0 | 6.0 | 6.5 |
| Compound 6 | 40.5 | 24.2 | 6.5 | 6.5 |
| Compound 7 | 40.0 | 23.7 | 6.0 | 6.5 |
| Compound 8 | 40.4 | 23.5 | 6.5 | 7.0 |
| Compound 9 | 39.8 | 24.0 | 6.0 | 6.5 |
| Compound 10 | 39.6 | 23.1 | 6.5 | 7.5 |
| Compound 11 | 40.6 | 23.0 | 6.5 | 7.5 |
| Compound 12 | 40.1 | 24.2 | 6.5 | 6.5 |
| Compound 13 | 40.0 | 24.0 | 5.5 | 6.0 |
| Compound 14 | 39.7 | 23.9 | 5.5 | 6.5 |
| Cetylpyridinium | 41.0 | 24.4 | 6.0 | 6.0 |
| chloride | | | | |
| TEGOPREN ® 6921 | 45.4 | >28 | 3.0 | 3.0 |
| TEGOTEX ® 8080 | 46.4 | >28 | 3.0 | 3.0 |
| TEGO ® Dispers 652 | 42.1 | 25.7 | 4.5 | 5.0 |

The results show that the noninventive dispersants lead to a significantly poorer property profile when using solids, in particular a higher thermal conductivity and a poorer surface. With the inventive dispersants, on the other hand, it is possible to significantly improve the property profile compared to noninventive dispersants.

### Example 2: Dispersion Behaviour

The performance comparison was carried out using the formulations shown in Table 9. For this, phenolic resin and dispersant (batch size: 250 g) were weighed out and mixed a disc stirrer (diameter 6 cm) at 1000 rpm for 30 s. The solid was then added with the disc stirrer still running (2000 rpm) and mixed in for a further 45 s. The formulations were then transferred to glass vessels, sealed, and the time until complete sedimentation measured.

After storage upright for 21 days at room temperature, all samples were redispersed and redispersibility was evaluated on a scale from 1 to 3. A score of 1 means that the sample could be redispersed just by using an electric laboratory stirrer (300 rpm for 30 s). A score of 2 was awarded if redispersion could be achieved with 800 rpm for 60 s. A score of 3 was awarded to samples in which a very fine, compact sediment had formed that could not be redispersed by one of the two mentioned methods.

TABLE 9
Formulation for testing dispersion behaviour.
Amounts stated are in parts by weight.

| | Formu- | Formu- | Formu- | Formu- | Formu- |
|---|---|---|---|---|---|
| Component | la F | la G | la H | la I | la J |
| Phenolic resin* | 100 | 100 | 100 | 100 | 100 |
| Dispersant | 5 | 2 | 2 | 8 | 2 |
| Red phosphorus | 10 | | | | |
| Ammonium | | 10 | | | |
| polyphosphate | | | | | |
| Melamine | | | 10 | | |
| Recycled phenolic | | | | 10 | |
| foam** | | | | | |
| Lignin from | | | | | 10 |
| hardwood | | | | | |

*Phenolic resin Cellobond ® J6014L from Bakelite
**Phenolic foam insulation panel ground in a pinned-disk mill (cryogenic grinding with liquid nitrogen, circumferential speed 120 m/s)

The results are shown in Tables 10 and 11.

TABLE 10
Sedimentation stability.

| | Formu- | Formu- | Formu- | Formu- | Formu- |
|---|---|---|---|---|---|
| Dispersant | la F | la G | la H | la I | la J |
| Without dispersant | 48 h | 48 h | 48 h | 24 h | 48 h |
| additive | | | | | |
| Compound 1 | 60 h | 60 h | 48 h | 36 h | 60 h |
| Compound 2 | 60 h | 60 h | 60 h | 48 h | 60 h |
| Compound 3 | 60 h | 60 h | 60 h | 48 h | 60 h |
| Compound 4 | 54 h | 72 h | 60 h | 36 h | 60 h |
| Compound 5 | 72 h | 72 h | 72 h | 36 h | 72 h |
| Compound 6 | 60 h | 72 h | 60 h | 24 h | 72 h |
| Compound 7 | 72 h | 72 h | 96 h | 48 h | 60 h |
| Compound 8 | 60 h | 60 h | 96 h | 48 h | 72 h |
| Compound 9 | 72 h | 60 h | 72 h | 48 h | 72 h |
| Compound 10 | 72 h | 60 h | 72 h | 48 h | 60 h |
| Compound 11 | 72 h | 72 h | 72 h | 48 h | 72 h |
| Compound 12 | 96 h | 96 h | 96 h | 48 h | 96 h |
| Compound 13 | 96 h | 96 h | 96 h | 48 h | 72 h |
| Compound 14 | 96 h | 96 h | 96 h | 48 h | 72 h |
| Cetylpyridinium | 54 h | 54 h | 60 h | 36 h | 54 h |
| chloride | | | | | |
| TEGOPREN ® 6921 | 36 h | 48 h | 36 h | 16 h | 36 h |
| TEGOTEX ® 8080 | 36 h | 36 h | 24 h | 24 h | 48 h |
| TEGO ® Dispers 652 | 48 h | 48 h | 48 h | 24 h | 48 h |

TABLE 11
Redispersibility.

| | Formu- | Formu- | Formu- | Formu- | Formu- |
|---|---|---|---|---|---|
| Dispersant | la F | la G | la H | la I | la J |
| Without dispersant | 3 | 3 | 3 | 2 | 2 |
| additive | | | | | |
| Compound 1 | 1 | 1 | 2 | 1 | 1 |
| Compound 2 | 1 | 1 | 2 | 2 | 1 |
| Compound 3 | 1 | 1 | 2 | 2 | 1 |
| Compound 4 | 1 | 1 | 2 | 2 | 1 |
| Compound 5 | 1 | 1 | 2 | 1 | 1 |
| Compound 6 | 2 | 1 | 1 | 1 | 1 |
| Compound 7 | 2 | 2 | 1 | 1 | 2 |
| Compound 8 | 2 | 2 | 1 | 1 | 2 |
| Compound 9 | 1 | 1 | 1 | 2 | 1 |
| Compound 10 | 1 | 1 | 1 | 2 | 1 |
| Compound 11 | 1 | 1 | 2 | 2 | 1 |
| Compound 12 | 1 | 1 | 2 | 1 | 1 |
| Compound 13 | 1 | 1 | 1 | 1 | 1 |
| Compound 14 | 1 | 1 | 1 | 1 | 1 |
| Cetylpyridinium | 2 | 2 | 2 | 2 | 1 |
| chloride | | | | | |
| TEGOPREN ® 6921 | 3 | 3 | 3 | 2 | 2 |
| TEGOTEX ® 8080 | 3 | 3 | 3 | 2 | 2 |
| TEGO ® Dispers 652 | 2 | 2 | 3 | 2 | 2 |

In all cases investigated, an improvement in sedimentation stability and in redispersibility was achieved compared to formulations without dispersants/formulations without the dispersants of the invention. In particular, the formation of a solid, compact sediment was avoided. The invention therefore permits very good redispersibility of the solid in the event of sedimentation after protracted storage, which means that, for example, constant stirring or mixing during storage for long periods is no longer necessary.

1-16. (canceled)

17. A composition for producing a phenolic foam, comprising at least one phenolic resin, at least one blowing agent, at least one catalyst, and at least one solid, and wherein the composition further comprises at least one surfactant selected from silicon-free quaternary ammonium compounds.

18. The composition of claim 17, wherein the at least one surfactant is selected from the group consisting of: an ester quat of formula (1), an ester quat of formula (2), an alkyl quat of formula (3), an imidazolinium quat of formula (4), and an amidoamine quat of formula (5) and cetylpyridinium chloride,
wherein in formula 1 and 2: 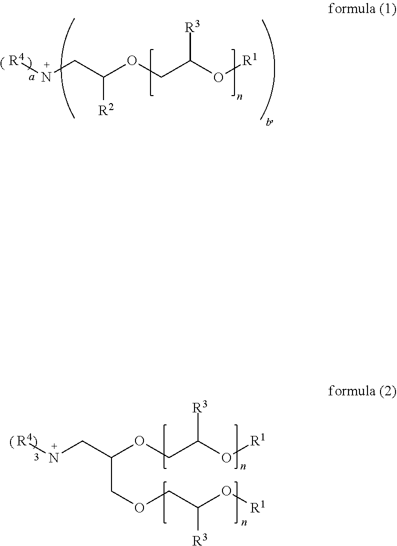
R¹ is an acyl radical of a saturated or mono- or polyunsaturated, linear or a branched fatty acid having a chain length of 8 to 22 carbon atoms, or the acyl radical of ricinoleic acid, or hydrogen;
wherein a compound of formula (1) or (2) may contain different radicals R¹;
with the proviso that at least one radical R¹ must be one of said acyl radicals;
R² is each independently an alkyl radical having 1 to 6 carbon atoms or hydrogen;
R³ is each independently an alkyl radical having 1 to 6 carbon atoms or hydrogen;
R⁴ is an alkyl radical having 1 to 6 carbon atoms, a hydroxyethyl radical or hydrogen, wherein a compound of formula (1) and/or (2) may contain different R⁴ radicals;
n=0 to 20;
a=1 to 3 and b=1 to 3;
with the proviso that a+b=4;
and/or wherein in formula 3: 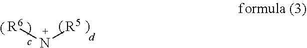
R⁵ is a saturated or mono- or polyunsaturated, linear or branched alkyl radical having a chain length of 8 to 24 carbon atoms, wherein a compound of formula (3) may contain different R⁵ radicals;
R⁶ is an alkyl radical having 1 to 6 carbon atoms, a hydroxyethyl radical, a benzyl radical or hydrogen, wherein a compound of formula (3) to contain different R⁶ radicals;
c=1 to 3 and d=1 to 3;
with the proviso that c+d=4;
and/or wherein in formula 4: 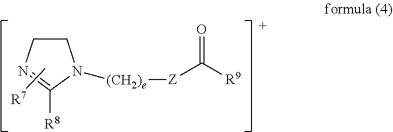
R⁷ is an alkyl radical having 1 to 6 carbon atoms or a hydroxyethyl radical or hydrogen;
R⁸ is a saturated or mono- or polyunsaturated, linear or branched alkyl radical having 8 to 22 carbon atoms or a radical O (CO) R¹⁰, wherein R¹⁰ is an aliphatic, saturated or mono- or polyunsaturated, linear or branched alkyl radical having 7 to 21 carbon atoms;
R⁹ is an aliphatic, saturated or mono- or polyunsaturated, linear or branched alkyl radical having 7 to 21 carbon atoms;
Z is an NH group or oxygen;
e is an integer between 1 and 4;
and/or wherein in formula 5: 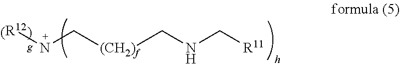
R¹¹ is a saturated or mono- or polyunsaturated, linear or branched alkyl radical having a chain length of 7 to 21 carbon atoms;
R¹² is an alkyl radical having 1 to 6 carbon atoms, a hydroxyethyl radical or hydrogen, wherein a compound of formula (5) may contain different R¹² radicals;
f is an integer between 0 and 5;
h=1 or 2 and g=2 or 3;
with the proviso that h+g=4;
wherein a compound of formula (5) in which h=2 may have different values for f and contain different R¹¹ radicals;
and if R⁴, R⁶, R⁷ or R¹² includes a hydroxyethyl radical, said hydroxyethyl radical may be alkoxylated and the optionally alkoxylated hydroxyethyl radical may contain repeat units based on ethylene oxide, propylene oxide, butylene oxide and/or styrene oxide and comprise 1-15 repeat units.

19. The composition of claim 18, wherein:
in formula (1) or (2), R² is hydrogen, methyl, ethyl, propyl or isopropyl; R³ is methyl, ethyl, propyl or isopropyl; and R⁴ is methyl, ethyl, propyl or isopropyl;
in formula (3), R⁶ is methyl, ethyl, propyl, isopropyl or benzyl;
in formula (4), R⁷ is methyl, ethyl, propyl or isopropyl; and
in formula (5), R¹² is methyl, ethyl, propyl or isopropyl.

20. The composition of claim 18, wherein, in formula (1) and/or formula (2), R¹ is each independently selected from the group consisting of: acyl radicals of acids from the group consisting of: oleic acid, isostearic acid, lauric acid, palmitic acid, elaidic acid, vaccenic acid, gadoleic acid, eicosenoic acid, cetoleic acid, erucic acid, nervonic acid, linoleic acid, alpha-linolenic acid, gamma-linolenic acid, calendic acid, punicic acid, alpha-eleostearic acid, beta-eleostearic acid, arachidonic acid, timnodonic acid, clupanodonic acid and cervonic acid.

21. The composition of claim 18, wherein, in formula (1), a=b=2 and/or, in formula (5), h=1 and g=3.

22. The composition of claim 19, wherein, in formula (1), a=b=2 and/or, in formula (5), h=1 and g=3.

23. The composition of claim 18, wherein the composition additionally comprises at least one counteranion to the compounds of general formulas (1), (2), (3), (4) and/or (5) selected from the group consisting of: chloride, bromide, iodide, alkyl sulfate, ethylsulfate, alkyl sulfonate, triflate, tosylate, phosphate, sulfate, hydrogen sulfate, lactate, glycolate, acetate and citrate.

24. The composition of claim 21, wherein the composition additionally comprises at least one counteranion to the compounds of the general formulas (1), (2), (3), (4) and/or (5) selected from the group consisting of chloride, bromide, iodide, alkyl sulfate, ethylsulfate, alkyl sulfonate, triflate, tosylate, phosphate, sulfate, hydrogen sulfate, lactate, glycolate, acetate and citrate.

25. The composition claim 17, wherein the at least one solid is selected from the group consisting of:
(a) solid flame retardants, melamine, melamine-coated ammonium polyphosphate, ammonium polyphosphate microencapsulated in melamine, ammonium polyphosphate microencapsulated in melamine-formaldehyde resin, melamine cyanurate, red phosphorus, zinc borate, melamine polyphosphate, expandable graphite and antimony trioxide;
(b) plastic powder;
(c) calcium carbonate, graphite, graphene, lignin, lignocellulose, metal hydroxides, metal carbonates, metal oxides, and metal powders.

26. The composition claim 17, wherein the at least one solid is ammonium polyphosphate, aluminium hydroxide, magnesium hydroxide, calcium carbonate, magnesium carbonate, barium carbonate; zinc carbonate, aluminium oxide, zinc oxide or zinc powder.

27. The composition of claim 25, wherein the solid flame retardant comprises red phosphorus and/or ammonium polyphosphate.

28. The composition of claim 17, wherein at least one plastic powder is present, the at least one plastic powder consisting of at least one plastic selected from the group consisting of: polyethylene, polypropylene, polyamide, polyester, polystyrene, polyacrylate, polymethyl methacrylate, polycarbonate, styrene-acrylonitrile copolymers, polyether, polylactic acid, polyurethane, phenolic resin, phenolic foam, polysulfone, polyethersulfone, polyetherimide, polyimide and mixtures thereof.

29. The composition of claim 17, wherein at least one solid is a powder having an average diameter of <500 μm.

30. The composition of claim 17, wherein at least one surfactant is present in a total amount of 0.1 to 20 parts by weight based on 100 parts by weight of the total phenolic resin used.

31. The composition of claim 17, wherein at least one solid is present in a total amount of 1 to 100 parts by weight, based on 100 parts by weight of the total phenolic resin used.

32. The composition of claim 17, wherein alkoxylated castor oil in a total amount of 0.5 to 10 parts by weight, based on 100 parts by weight of the total phenolic resin used, is additionally present; and/or
at least one polyether siloxane is additionally present in an amount of 0.5 to 10 parts by weight, based on 100 parts by weight of the total phenolic resin used.

33. The composition of claim 17, wherein the at least one blowing agent is selected from the group consisting of:
hydrocarbons having 3, 4 or 5 carbon atoms; and
halogenated hydrocarbons having 3, 4 or 5 carbon atoms.

34. The composition of claim 17, wherein the at least one blowing agent is selected from the group consisting of:
cyclo-, iso- and/or n-pentane; and
hydrofluoroolefins and/or hydrohaloolefins.

35. A process for producing a phenolic foam using a reaction mixture that comprises the composition of claim 17.

36. A phenolic foam produced by the process of claim 35.
